(19) United States
(12) Patent Application Publication
(10) Pub. No.: US 2005/0269040 A1
(43) Pub. Date: Dec. 8, 2005

(54) Roman blind structure

(76) Inventor: Leslie Nien, Changhua Hsien (TW)

Correspondence Address: TROXELL LAW OFFICE PLLC;SUITE 1404, 5205 LEESBURG PIKE, FALLS CHURCH, VA, 22041, US

(21) Appl. No.: 10/900,143

(22) Filed: Jul. 28, 2004

(30) Foreign Application Priority Data
Jun. 3, 2004 (TW) 093208777

(51) Int. Cl. E06B 3/48

(52) U.S. Cl. 160/84.01

(57) ABSTRACT

A Roman blind structure includes a Roman blind made up of a telescopic upper beam, and a blind body of a proper length and width fixedly attached to the underside of the telescopic upper beam thereof wherein the blind body is provided with a plurality of long tubular tunnels equidistantly folded and seamed up from top to bottom at one side thereof for adjustable rods, each having a plurality of dividing grooves properly cut in equal space at the surface thereon, to be adapted therein respectively. At preset positions of the left and right sides of each long tubular tunnel are respectively located a retaining member with a C-shaped clamping part extending at one side thereof to clamp tight the adjustable rod adapted inside the long tubular tunnel thereby, and the retaining members are also equipped with cord-passage holes, each protruding levelly at one side of the C-shaped clamping part thereof, for pull cords to be sequentially led there-through before fixedly tied up to the bottommost cord-passage holes thereof. When the telescopic upper beam is properly adjusted to fit to a window frame, the adjustable rods are directly bent downwards by force along the dividing grooves to break off extra sections of the adjustable rods thereof without any other tools applied thereto, and an extra part of the adjusted blind body is collected either at the middle section or at both the left/right sides of the adjustable rods in wavy wrinkles, achieving versatile visual effects of the Roman blind as well as facilitating an easy and speedy assembly of the present invention.

### BACKGROUND OF THE INVENTION

The present invention is related to a Roman blind structure, including a telescopic upper beam of a Roman blind, and a blind body of a proper length and width fixedly attached to the underside of the telescopic upper beam thereof wherein the blind body is provided with a plurality of long tubular tunnels equidistantly folded and seamed from top to bottom at one side thereof for adjustable rods, each having a plurality of dividing grooves properly cut in equal space at the surface thereon, to be adapted therein respectively; whereby, when the telescopic upper beam is properly adjusted to fit to a window frame, the adjustable rods are directly bent downwards by force along the dividing grooves thereof to break off extra sections of the adjustable rods thereof without any other tools applied thereto, and an extra part of the adjusted blind body is collected either at the middle section or both the left/right sides of the adjustable rods in wavy wrinkles, achieving versatile visual effects of the Roman blind as well as facilitating an easy and speedy assembly of the present invention.

Please refer to FIG. 1. A conventional Roman blind structure includes a Roman blind 10 made up of an upper beam 11, and a blind body 12 of a proper length and width fixedly attached to the underside of the upper beam 11 thereof wherein the blind body 12 is sequentially folded backwards for a certain length and equidistantly seamed up from top to bottom to form a plurality of long tubular tunnels 14 for support rods 13 to be adapted therein respectively, and a plurality of cord-passage hoops 15 each having a retaining piece 16 attached thereto are symmetrically disposed at both left and right sides of the long tubular tunnels 14 thereon for both ends of a pull cord 17 extending downwards from the upper beam 11 to be led sequentially there-through till securely fixed to the bottommost cord-passage hoops 15 thereof. Thus, the pull cord 17 is drawn to actuate the bottommost cord-passage hoops 15, sequentially raising upwards the other cord-passage hoops 15 and the long tubular tunnels 14 therewith to gather up the blind body 12 suspending downwards in multi-layers.

There are some drawbacks to such conventional Roman blind structure. First, the retaining pieces 16, fixedly seamed in equal space at both left and right sides of the long tubular tunnels 14 according to the size of the blind body 12, are unable to be adjusted to fit to window frames of various sizes. In case the blind body 12 and the supporting rods 13 are properly trimmed in length at a cutting line B according to the size of a window frame A as shown in FIG. 2, the retaining pieces 16 will be asymmetrically located and the pull cord 17 will be awkwardly led through the cord-passage hoops 15 in assembly accordingly, which can destroy the overall beauty of the Roman blind 10 in display and cause disadvantages and inconvenience in decoration and assembly thereof. Thus, the conventional blind structure is quite limited in practical use and reduced in the competitive power thereof. Second, in case the Roman blind 10 is unfit to the size of the window frame A, the supporting rods 13 must be individually trimmed in length via cutting tools, which is quite tedious and time-consuming in the cutting operation thereof

### SUMMARY OF THE PRESENT INVENTION

It is, therefore, the primary purpose of the present invention to provide a Roman blind structure, including a telescopic upper beam of a Roman blind, and a blind body of a proper length and width fixedly attached to the underside of the telescopic upper beam thereof wherein the blind body is provided with a plurality of long tubular tunnels equidistantly folded and seamed from top to bottom at one side thereof for adjustable rods, each having a plurality of dividing grooves properly cut in equal space at the surface thereon, to be adapted therein respectively; whereby, when the telescopic upper beam is properly adjusted to fit to a window frame, the adjustable rods are directly bent downwards by force along the dividing grooves thereof to break off extra sections of the adjustable rods thereof without any other tools applied thereto, facilitating an easy and speedy assembly thereof.

It is, therefore, the second purpose of the present invention to provide a Roman blind structure wherein a plurality of retaining members each having a clamping part disposed at one side thereof are detachably mounted to the left and right sides of the long tubular tunnels to clamp tight the adjustable rods adapted inside the long tubular tunnels thereof, permitting the retaining members to be properly relocated in positions according to the adjusted telescopic upper beam and the blind body thereof so that pull cords can be symmetrically held in place by cord-passage holes of the retaining members thereof, maintaining the overall beauty of the Roman blind in display.

It is, therefore, the third purpose of the present invention to provide a Roman blind structure wherein the blind body is easily adjusted according to the telescopic upper beam to fit to a smaller window frame with the extra part thereof either gathering at the middle section or evenly collected at both left and right sides of the adjustable rods thereof in wavy wrinkles and limited by the retaining members at both sides without the blind body being trimmed in the adjustment thereof, achieving versatile visual effects and stylistic changes of the present invention.

### BRIEF DESCRIPTION OF THE DRAWINGS

FIG. 1 is a perspective view of a conventional Roman blind.

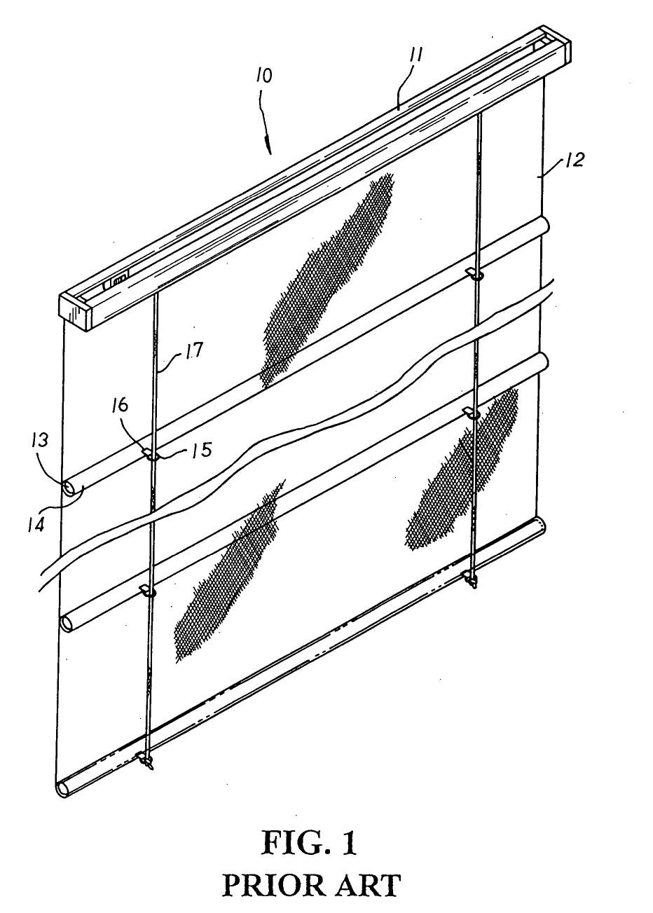

FIG. 2 is a diagram showing the conventional Roman blind mounted to a window frame in practical use.

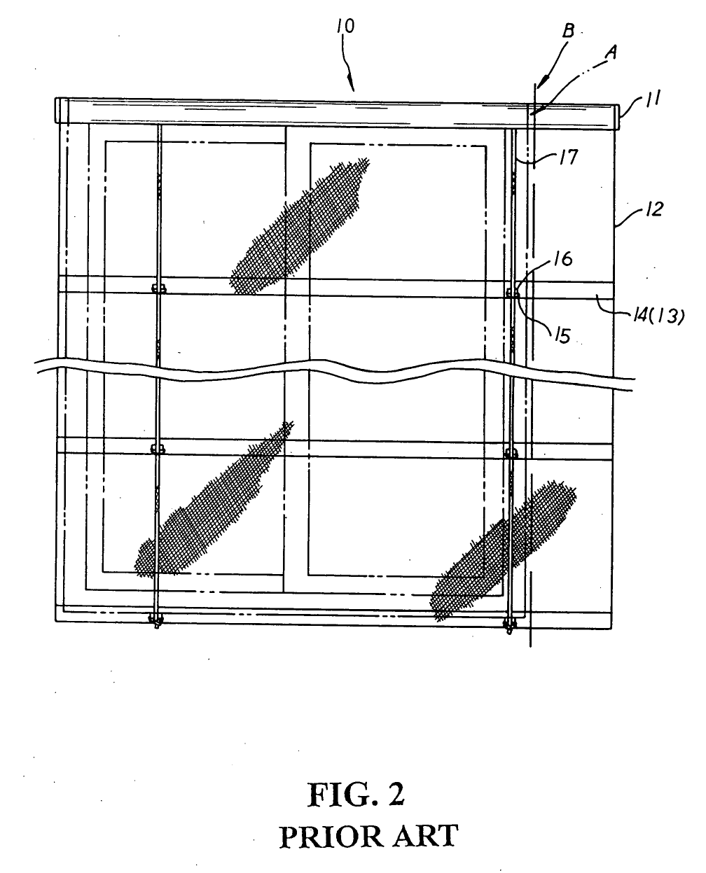

FIG. 3 is a perspective exploded view of the present invention.

FIG. 4 is a diagram showing the present invention adjusted to fit to a window frame in operation.

FIG. 5 is a diagram showing another embodiment of the present invention adjusted to fit to a widow frame in operation.

### DETAILED DESCRIPTION OF THE PREFERRED EMBODIMENTS

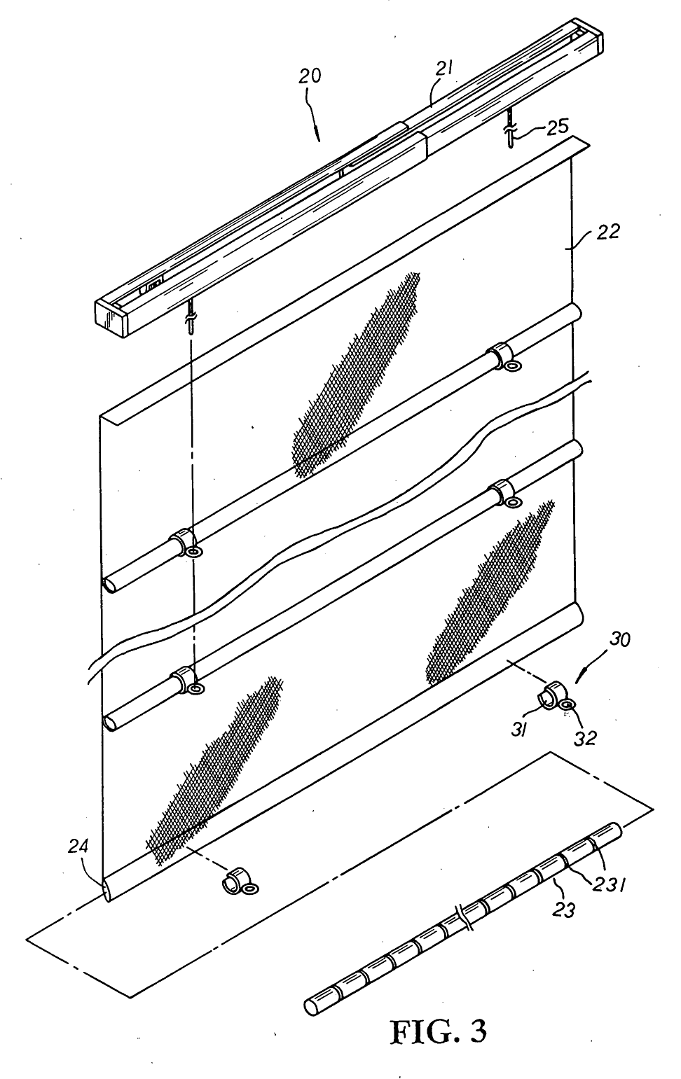

Please refer to FIG. 3. The present invention is related to a Roman blind structure, including a Roman blind 20 made up of a telescopic upper beam 21, and a blind body 22 of a proper length and width fixedly attached to the underside of the telescopic upper beam 21 thereof. The blind body 22 is equidistantly folded backwards for a certain length into double layers and sequentially seamed up from top to bottom at one side thereof to provide a plurality of long tubular tunnels 24 each for an adjustable rod 23 to be located therein. The adjustable rod 23 is provided with a plurality of dividing grooves 231 properly cut in equal space at the surface thereon. At preset positions of the left and right sides of each long tubular tunnel 24 are respectively located a retaining member 30 with a C-shaped clamping part 31 extending at one side thereof in conformance to the outer diameter of the adjustable rod 23 to synchronically clamp tight the adjustable rod 23 adapted inside the long tubular tunnel 24 thereby. The retaining members 30 are also equipped with cord-passage holes 32, each protruding levelly at one side of the C-shaped clamping part 31 thereof, for pull cords 25 extending downwards from the inner side of the telescopic upper beam 21 to be sequentially led there-through before fixedly tied up to the bottommost cord-passage holes 32 thereof. In operation, the pull cords 25 are drawn to raise upwards the bottommost cord-passage holes 32 and collect the other cord-passage holes 32 sequentially from bottom to top therewith. Thus, the long tubular tunnels 24 with the adjustable rods 23 retained therein are sequentially lifted upwards to fold up the blind body 22 suspending downwards in multi-layers.

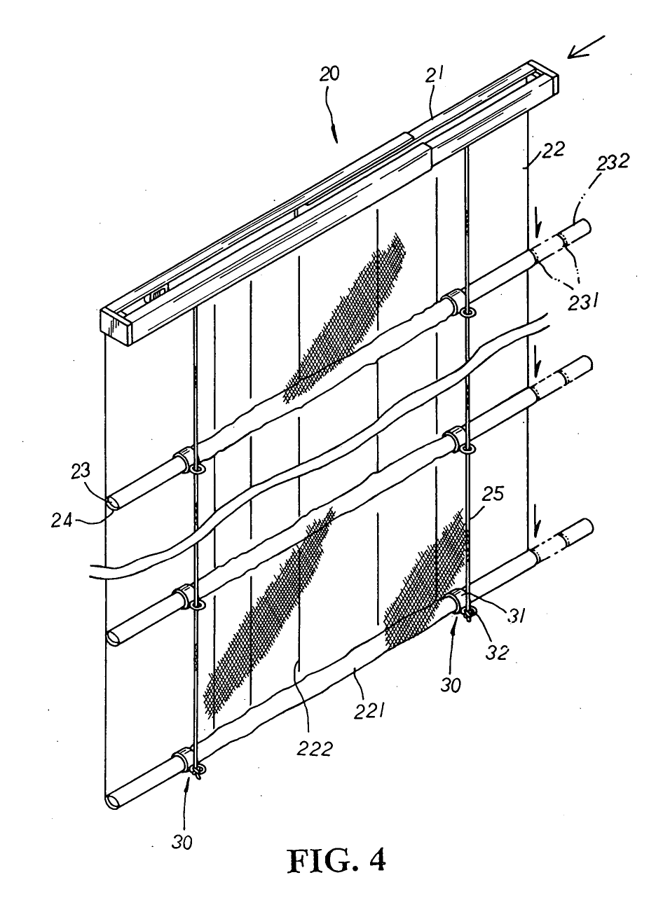

Please refer to FIG. 4. The Roman blind 20 is easily adjusted smaller in size to fit to a window frame via the retaining members 30 detachably set apart from the long tubular tunnels 24 of the blind body 22 and via the adjustable rods 23 with the dividing grooves 231 equidistantly cut thereon. In the adjustment thereof, the retaining members 30 attached at the left/right sides of the long tubular tunnels 24 are pulled outwards to detach the clamping parts 31 thereof from the long tubular tunnels 24 and the adjustable rods 23 as well. The telescopic upper beam 21 is then adjusted in length to fit to the size of the window frame with an extra part 221 of the blind body 22 collected towards the middle section under the telescopic upper beam 21 and tied up in wavy wrinkles, and the left and right side edges of the blind body 22 thereof neatly aligned with the axial line of the telescopic upper beam 21 thereof. According to the size of the shortened adjusted telescopic upper beam 21, the adjustable rods 23 thereof are directly bent downwards by force along the dividing grooves 231 to break off extra sections 232 exposed outside the long tubular tunnels 221 thereof without any other tools applied thereto. The detached retaining members 30 are then relocated relative to the width of the altered adjustable rods 23 and symmetrically clamped at proper positions of the long tubular tunnels 24 thereof. Thus, the extra part 221 of the blind body 22 is limited between the relocated retaining members to form a wrinkled and wavy decoration area 222 at the middle section of the blind body 22, providing versatile visual effects of the Roman blind 20 as well as facilitating the assembly and adjustment of the present invention in an easy and speedy manner.

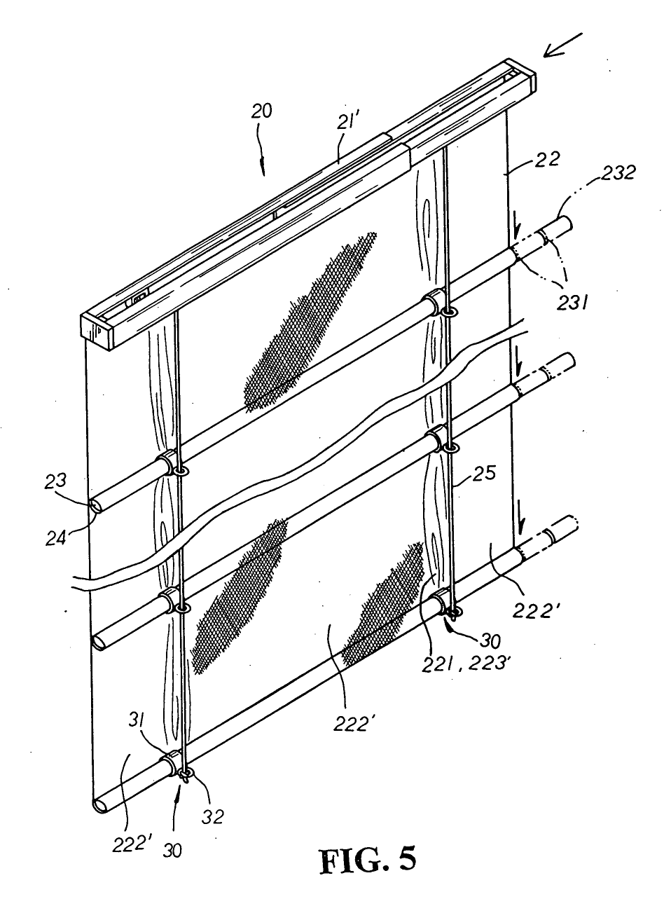

Please refer to FIG. 5. The extra part 221 of the blind body 22 can also be evenly collected in wavy wrinkles at both left and right sides thereof and neatly held in place by the clamping parts 31 of the retaining members 30 to provide a smooth plane area 222′ in the middle section of the blind body 22 and wrinkled wavy areas 223′ alternatively arranged at both left and right sides thereof, achieving versatile stylistic changes of the Roman blind 20.

1. A Roman blind structure, including a Roman blind made up of a telescopic upper beam, a blind body of a proper length and width fixedly attached to the underside of the telescopic upper beam thereof, and pull cords wherein the blind body is provided with a plurality of long tubular tunnels equidistantly folded and seamed from top to bottom at one side thereof for adjustable rods to be adapted therein respectively, and at preset positions of the left and right sides of each long tubular tunnel are respectively located a retaining member with a C-shaped clamping part extending at one side thereof to clamp tight the adjustable rod adapted inside the long tubular tunnel thereby; the retaining members are also equipped with cord-passage holes, each protruding levelly at one side of the C-shaped clamping part thereof, for pull cords extending downwards from the inner side of the upper beam to be sequentially led there-through before fixedly tied up to the bottommost cord-passage holes thereof; the present invention being characterized by that,
the adjustable rod is provided with a plurality of dividing grooves properly cut in equal space at the surface thereon, and, when the telescopic upper beam is adjusted in length to fit to a window frame, the retaining members detachably mounted to the long tubular tunnels thereof can be easily relocated at proper positions of the long tubular tunnels for clamping tight the adjustable rods retained inside the long tubular tunnels thereof so that the pull cords can be symmetrically arranged in positions relative to the retaining members to maintain a neat and clean appearance of the blind body as a whole; besides, the adjustable rods thereof are directly bent downwards by force along the dividing grooves to break off extra sections exposed outside the long tubular tunnels thereof without any other tools applied thereto, facilitating the assembly of the present invention in an easy and speedy manner.

2. The Roman blind structure as claimed in claim 1 wherein the extra part of the adjusted blind body thereof can be collected at the middle section of the adjustable rods thereof in wavy wrinkles and limited by the retaining members at both left and right sides of the long tubular tunnels to form a wrinkled and wavy decoration area at the middle section of the Roman blind thereof.

3. The Roman blind structure as claimed in claim 1 wherein the extra part of the adjusted blind body can also be evenly collected in wavy wrinkles at both left and right sides of the adjustable rods thereof and neatly held in place by the clamping parts of the retaining members to provide a smooth plane area at the middle section of the blind body and wrinkled wavy areas alternatively arranged at both left and right sides thereof, achieving versatile visual effects and stylistic changes of the Roman blind thereof.
